(19) United States
(12) Patent Application Publication
(10) Pub. No.: US 2024/0246444 A1
(43) Pub. Date: Jul. 25, 2024

(54) INFORMATION PROCESSING METHOD, INFORMATION PROCESSING DEVICE, AND STORAGE MEDIUM

(71) Applicant: TOYOTA JIDOSHA KABUSHIKI KAISHA, Toyota-shi (JP)

(72) Inventors: Ai MIYATA, Osaka (JP); Ibuki SHIMADA, Miyoshi-shi (JP); Hiroki TAKEISHI, Tokyo (JP); Koki MORIYA, Nagakute-shi (JP); Koji UEDA, Funabashi-shi (JP)

(73) Assignee: TOYOTA JIDOSHA KABUSHIKI KAISHA, Toyota-shi (JP)

(21) Appl. No.: 18/527,541

(22) Filed: Dec. 4, 2023

(30) Foreign Application Priority Data
Jan. 25, 2023 (JP) 2023-009650

(51) Int. Cl. B60L 53/66; B60L 53/62; G06Q 20/14; G06Q 50/06

(52) U.S. Cl. CPC B60L 53/665; B60L 53/62; G06Q 20/14; G06Q 50/06

(57) ABSTRACT

An information processing method by an information processing device, comprising: receiving from a user terminal a charging request designating an expected travel distance of a vehicle; and traveling the expected travel distance from electricity consumption data associated with a user of the user terminal transmitting information indicating the charging amount and the charging cost to the user terminal; receiving a payment request for the charging cost from the user terminal; including performing.

### CROSS-REFERENCE TO RELATED APPLICATION

This application claims priority to Japanese Patent Application No. 2023-009650 filed on Jan. 25, 2023, incorporated herein by reference in its entirety.

### BACKGROUND

### 1. Technical Field

The present disclosure relates to an information processing method, an information processing device, and a storage medium.

### 2. Description of Related Art

There is conventionally known a service in which a power feeding vehicle comes to feed power to a host vehicle when a request to feed power to the host vehicle is made through an app (see NIO LIMITED, “NIO Power”, [online], 2022, [retrieved Dec. 14, 2022], Internet <URL: https://www.nio.com/nio-power>, for example).

### SUMMARY

In the background art described above, a settlement error may occur when a charging cost is paid after the charging is completed. In this case, payment of the charging cost may not be executed reliably.

An object of the present disclosure, which has been made in view of such circumstances, is to reliably execute payment of a charging cost.

An aspect of the present disclosure provides an information processing method performed by an information processing device, including: receiving, from a user terminal, a charging request specifying an expected travel distance of a vehicle; calculating a charging amount and a charging cost required to travel the expected travel distance from electricity consumption data associated with a user of the user terminal; transmitting information indicating the charging amount and the charging cost to the user terminal; and receiving a payment request for the charging cost from the user terminal and executing payment.

Another aspect of the present disclosure provides an information processing device including a control unit, in which the control unit executes operation including: receiving, from a user terminal, a charging request specifying an expected travel distance of a vehicle; calculating a charging amount and a charging cost required to travel the expected travel distance from electricity consumption data associated with a user of the user terminal; transmitting information indicating the charging amount and the charging cost to the user terminal; and receiving a payment request for the charging cost from the user terminal and executing payment.

Still another aspect of the present disclosure provides a storage medium that stores a program that causes a computer as a user terminal to execute operation including: receiving, via an input unit, a charging request specifying an expected travel distance of a vehicle; transmitting the charging request to an information processing device; receiving, from the information processing device, information indicating a charging amount and a charging cost required to travel the expected travel distance; displaying the information on a display unit; and transmitting a payment request to the information processing device upon receiving, via the input unit, an approval for payment for the charging cost.

According to an embodiment of the present disclosure, it is possible to reliably execute payment of a charging cost.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of an information processing system;

FIG. 2 is a block diagram showing the configuration of an information processing device;

FIG. 3 is a block diagram showing the configuration of each of the user terminal and worker terminal;

FIG. 4 is a sequence diagram showing operations of the information processing device and the user terminal;

FIG. 5 is a diagram showing the data structure of a charging DB (database);

FIG. 6 is a diagram showing an example of a screen displayed on the user terminal.

### DETAILED DESCRIPTION OF EMBODIMENTS

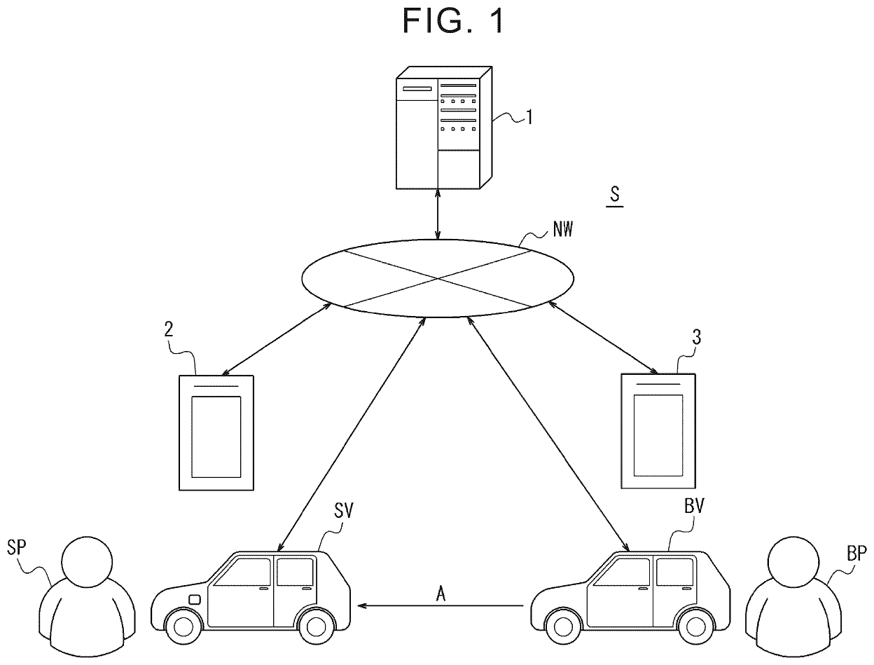

FIG. 1 is a schematic diagram of an information processing system S according to the present embodiment. The information processing system S includes an information processing device 1, a user terminal 2, a worker terminal 3, a power supply destination vehicle SV, and a power supply source vehicle BV that can communicate with each other via a network NW. Network NW includes, for example, a mobile communication network, a fixed communication network, or the Internet.

The user terminal 2 is operated by the user SP. The user SP drives the power supply destination vehicle SV or rides in the power supply destination vehicle SV. The worker terminal 3 is operated by the worker BP. The worker BP drives the power supply source vehicle BV or rides in the power supply source vehicle BV. The power supply source vehicle BV moves to the position of the power supply destination vehicle SV as in direction A, and supplies electric power from the power supply source vehicle BV to the power supply destination vehicle SV. Here, as an example, each of the power supply destination vehicle SV and the power supply source vehicle BV is a battery electric vehicle including a battery, but is not limited to this. As an alternative, the user SP does not have to get on the power supply destination vehicle SV. The worker BP does not have to get on the power supply source vehicle BV.

In FIG. 1, one information processing device 1, one user terminal 2, and one worker terminal 3 are shown for the sake of simplicity of explanation. However, the numbers of the information processing devices 1, the user terminals 2, and the worker terminals 3 are not limited to this. For example, the processes executed by the information processing device 1 according to the present embodiment may be executed by a plurality of the information processing devices 1 disposed in a distributed manner.

The information processing device 1 is installed in a facility such as a data center or a charging station. The information processing device 1 is, for example, a computer such as a server belonging to a cloud computing system or other computing systems.

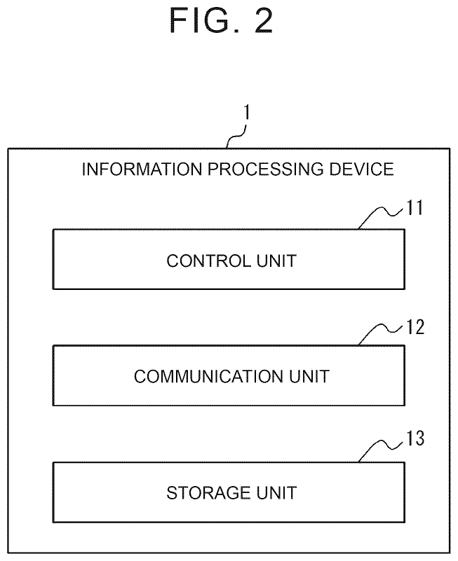

In FIG. 2, the internal configuration of the information processing device 1 will be described in detail.

The information processing device 1 includes the control unit 11, the communication unit 12, and a storage unit 13. The constituent components of the information processing device 1 are connected so as to be able to communicate with each other via a dedicated line, for example.

The control unit 11 includes, for example, one or more general-purpose processors including a Central Processing Unit (CPU) or a Micro Processing Unit (MPU). The control unit 11 may include one or more dedicated processors specialized for a specific process. The control unit 11 may include one or more dedicated circuits instead of including the processor. A dedicated circuit may be, for example, a Field-Programmable Gate Array (FPGA) or an Application Specific Integrated Circuit (ASIC). The control unit 11 may include an Electronic Control Unit (ECU). The control unit 11 transmits and receives information via the communication unit 12.

The communication unit 12 includes a communication module compatible with one or more wired or wireless Local Area Network (LAN) standards for connecting to the network NW. The communication unit 12 may include modules compatible with one or more mobile communication standards including Long Term Evolution (LTE), 4th Generation (4G), or 5th Generation (5G). The communication unit 12 may include a communication module and the like conforming to one or more short-range communication standards or specifications including Bluetooth (registered trademark), AirDrop (registered trademark), infrared data association (IrDA), ZigBee (registered trademark), FeliCa (registered trademark), or radio frequency identifier (RFID). The communication unit 12 transmits and receives information via the network NW.

The storage unit 13 includes a semiconductor memory, a magnetic memory, an optical memory, or a combination of at least two of them. However, the disclosure is not limited to this. A semiconductor memory is, for example, a Random Access Memory (RAM) or a Read Only Memory (ROM). RAM is, for example, Static Random Access Memory (SRAM) or Dynamic Random Access Memory (DRAM). ROM is, for example, Electrically Erasable Programmable Read-Only Memory (EEPROM). The storage unit 13 may function as, for example, a main storage device, an auxiliary storage device, or a cache memory. The storage unit 13 may store information on the result of analysis or processing by the control unit 11. The storage unit 13 may store various kinds of information and the like related to the operation or control of the information processing device 1. The storage unit 13 may store a system program, an application program, embedded software, and the like. The storage unit 13 maybe provided outside the information processing device 1 and accessed from the information processing device 1. Storage unit 13 includes a charging DB.

The user terminal 2 is, for example, a mobile terminal such as a mobile phone, a smart phone, a wearable device, or a tablet. Alternatively, the user terminal 2 may be a general purpose device such as a personal computer (PC) or a dedicated device.

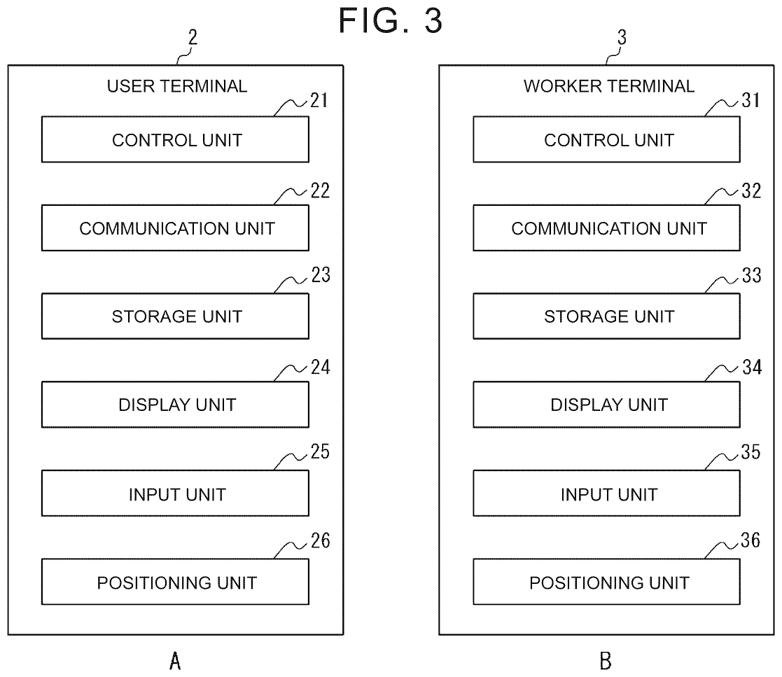

In A of FIG. 3, the internal configuration of the user terminal 2 is described in detail.

The user terminal 2 includes a control unit 21, a communication unit 22, a storage unit 23, a display unit 24 and an input unit 25. Each component of the user terminal 2 is communicably connected to each other via a dedicated line, for example.

The description of the hardware configuration of the control unit 21, the communication unit 22, and the storage unit 23 of the user terminal 2 maybe the same as the description of the hardware configuration of the control unit 11, the communication unit 12, and the storage unit 13 of the information processing device 1. The description here is omitted.

The display unit 24 is, for example, a display. The display is for example a Liquid Crystal Display (LCD) or an organic Electro Luminescence (EL) display. The display unit 24 maybe connected to the user terminal 2 as an external output device instead of being provided in the user terminal 2. As the connection method, for example, any method such as Universal Serial Bus (USB), High-Definition Multimedia Interface (HDMI) (registered trademark), or Bluetooth (registered trademark) can be used.

The input unit 25 is, for example, a physical key, a capacitive key, a pointing device, a touch screen integrated with a display, or a microphone. The input unit 25 receives an operation of inputting information used for the operation of the user terminal 2. The input unit 25 maybe connected to the user terminal 2 as an external input device instead of being provided in the user terminal 2. As a connection method, for example, any method such as a universal serial bus (USB), a high-definition multimedia interface (HDMI) (registered trademark), or Bluetooth (registered trademark) can be used.

The positioning unit 26 includes at least one Global Navigation Satellite System (GNSS) receiver. GNSS includes, for example, Global Positioning System (GPS), Quasi-Zenith Satellite System (QZSS), BeiDou, Global Navigation Satellite System (GLONASS), and/or Galileo. The satellites of the QZSS are referred to as quasi-zenith satellites. The positioning unit 26 acquires position information. “Positional information” is information that can identify the position of the user terminal 2, and includes coordinates, for example.

In B of FIG. 3, the internal configuration of the worker terminal 3 is explained in detail. The worker terminal 3 includes a control unit 31, a communication unit 32, a storage unit 33, a display unit 34, an input unit 35, and a positioning unit 36. Each component of the worker terminal 3 is connected to each other so as to be communicable via, for example, a dedicated line.

The description of the hardware configuration of the control unit 31, the communication unit 32, the storage unit 33, the display unit 34, the input unit 35, and the positioning unit 36 of the worker terminal 3 maybe the same as the description of the hardware configuration of the control unit 21, the communication unit 22, the storage unit 23, the display unit 24, the input unit 25, and the positioning unit 26 of the user terminal 2. The description here is omitted.

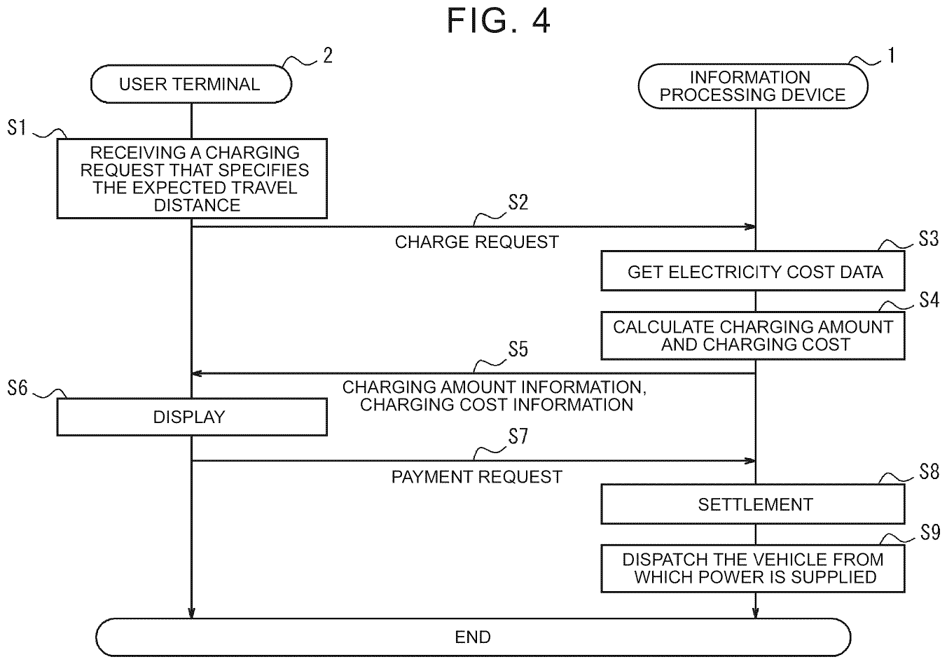

The information processing method by the information processing device 1 will be described in detail below with reference to FIG. 4. Here, as an example, a scene will be described in which the user SP operates the user terminal 2 to request power supply to the power supply destination vehicle SV.

In S1, the control unit 21 of the user terminal 2 receives a charging request designating the expected travel distance from the user SP via the input unit 25. The planned travel distance is, for example, 50 kilometers. As an additional example, the control unit 21 may receive specification of the charging time from the user SP in addition to specification of the expected travel distance.

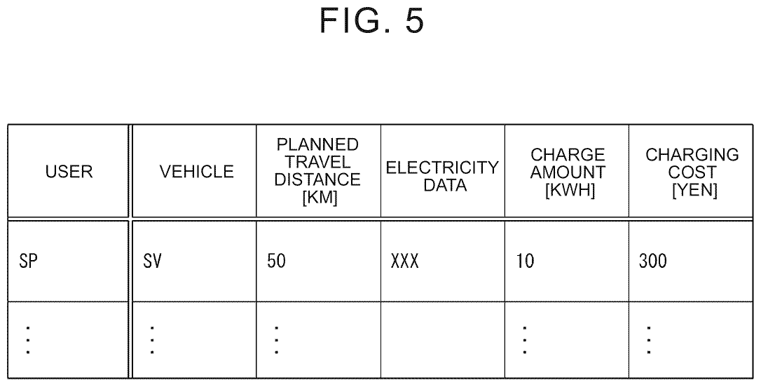

In S2, control unit 21 transmits a charging request to information processing device 1. As shown in FIG. 5, the control unit 11 stores the power supply destination vehicle SV and the expected travel distance in the storage unit 13 in association with the user SP.

In S3, the control unit 11 of the information processing device 1 acquires electricity consumption data associated with the user SP from the storage unit 13. The control unit 11 stores the electricity consumption data in the storage unit 13 in association with the user SP. The electricity consumption data may be electricity consumption data acquired during a predetermined period in the past. As an alternative example, the control unit 11 may collect past travel histories (for example, trip data) of the user SP and acquire electricity consumption data from the travel histories.

Alternatively or additionally, the electricity consumption data may be electricity consumption data obtained from other vehicles pre-registered by the user SP. For example, if the power supply destination vehicle SV is a rental car, the electricity consumption data varies depending on the driver of the power supply destination vehicle SV. Electricity cost data may then be obtained from other vehicles owned by the user SP. Other vehicles are registered in the information processing device 1 in advance.

In S4, the control unit 11 calculates the charging amount and the charging cost necessary for traveling the planned traveling distance from the electricity consumption data. The control unit 11 stores the charging amount and the charging cost in association with the user SP in the storage unit 13. As an alternative or an additional example, the control unit 11 may calculate the charging amount and the charging cost necessary for traveling the planned traveling distance from the State of Charge (SOC) information of the power supply destination vehicle SV.

In S5, the control unit 11 transmits information indicating the charging amount and the charging cost to the user terminal 2. As an additional example, the control unit 11 may transmit at least one of the following information to the user terminal 2 as a charging option.
Charging amount and charging cost when the power supply destination vehicle SV is fully charged
Charging amount when charging with the amount of money (that is, charging cost) specified by the user SP
Charging amount and charging cost corresponding to the charging period specified by the user SP

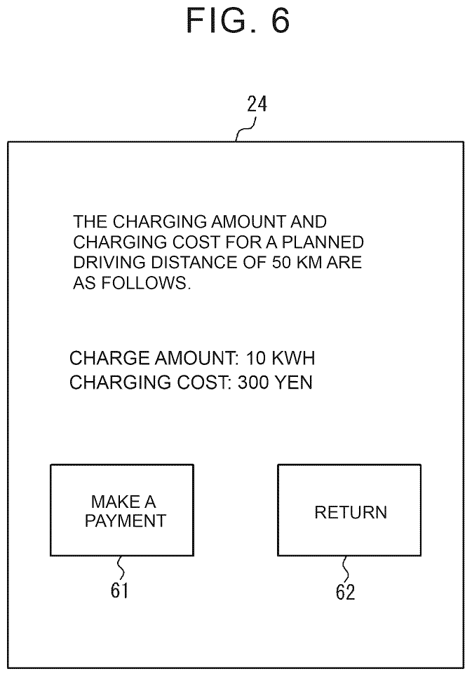

In S6, the control unit 21 displays information indicating the charging amount and the charging cost on the display unit 24. An example of the display screen is shown in FIG. 6. The display unit 24 displays an icon 61 for the user to approve the payment and an icon 62 for canceling the payment.

In S7, upon receiving approval for payment via the input unit 25, the control unit 21 transmits a payment request to the information processing device 1.

In S8, when the control unit 11 receives the settlement request, the control unit 11 executes the settlement using, for example, an account that stores the balance held by the user SP. In S9, the control unit 11 notifies the worker terminal 3 to dispatch the power supply source vehicle BV to the position of the power supply destination vehicle SV.

As described above, according to the present embodiment, the operation of the control unit 11 of the information processing device 1 is to receive, from the user terminal 2, a charging request designating the planned traveling distance of the power supply destination vehicle SV, and calculating the charging amount and the charging cost required to travel the planned travel distance from the electricity consumption data associated with the user of the user terminal 2, and transmitting information indicating the charging amount and the charging cost to the user terminal 2, and receiving an electricity charge payment request from the user terminal 2 and executing the payment. With this configuration, the information processing device 1 can settle the payment before the charging is completed, so that the charging cost can be reliably paid.

Further, according to the present embodiment, the operation of the control unit 11 includes collecting the travel history of the user and acquiring the electricity consumption data from the travel history. With this configuration, the information processing device 1 can improve the accuracy of estimating the charging amount and the charging cost.

Further, according to the present embodiment, the electricity consumption data includes electricity consumption data acquired from other vehicles registered in advance by the user SP. With this configuration, the information processing device 1 can reflect the habits of the user SP during normal driving in the charging amount and the charging cost even if the power supply destination vehicle SV is a rental car.

Although the present disclosure has been described above based on the drawings and the embodiment, it should be noted that those skilled in the art may make various modifications and alterations thereto based on the present disclosure. Other changes may be made without departing from the scope of the present disclosure. For example, the functions included in each means or step can be rearranged so as not to be logically inconsistent, and a plurality of means or steps can be combined into one or divided.

For example, in the above-described embodiments, a program for executing all or part of the functions or processes of the information processing device 1, the user terminal 2, and the worker terminal 3 can be recorded in a computer-readable recording medium (storage medium). The computer-readable recording medium includes a non-transitory computer-readable medium such as a magnetic recording device, an optical disc, a magneto-optical recording medium, or a semiconductor memory. Programs are distributed by, for example, selling, assigning, or lending portable recording media such as a digital versatile disc (DVD) or a compact disc read only memory (CD-ROM) on which the programs are recorded. Further, the distribution of the program may be performed by storing the program in a storage of a server and transmitting the program from the server to another computer. Further, the program may be provided as a program product. The present disclosure can also be realized as a program that can be executed by a processor.

What is claimed is:

1. An information processing method performed by an information processing device, the information processing method comprising:
receiving, from a user terminal, a charging request specifying an expected travel distance of a vehicle;
calculating a charging amount and a charging cost required to travel the expected travel distance from electricity consumption data associated with a user of the user terminal;
transmitting information indicating the charging amount and the charging cost to the user terminal; and
receiving a payment request for the charging cost from the user terminal and executing payment.

2. The information processing method according to claim 1, further comprising collecting a driving history of the user and acquiring the electricity consumption data from the driving history.

3. The information processing method according to claim 1, wherein the electricity consumption data include electricity consumption data acquired from a different vehicle previously registered by the user.

4. An information processing device including a control unit, wherein the control unit executes operation comprising:
receiving, from a user terminal, a charging request specifying an expected travel distance of a vehicle;
calculating a charging amount and a charging cost required to travel the expected travel distance from electricity consumption data associated with a user of the user terminal;
transmitting information indicating the charging amount and the charging cost to the user terminal; and
receiving a payment request for the charging cost from the user terminal and executing payment.

5. A non-transitory storage medium that stores a program that causes a computer as a user terminal to execute operation comprising:
receiving, via an input unit, a charging request specifying an expected travel distance of a vehicle;
transmitting the charging request to an information processing device;
receiving, from the information processing device, information indicating a charging amount and a charging cost required to travel the expected travel distance;
displaying the information on a display unit; and
transmitting a payment request to the information processing device upon receiving, via the input unit, an approval for payment for the charging cost.
